(19) United States
(12) Patent Application Publication
(10) Pub. No.: US 2006/0202641 A1
(43) Pub. Date: Sep. 14, 2006

(54) Method and device for measuring color temperature

(75) Inventors: Arnold Willem Buij, Eindhoven (NL); Karel Leo Manders, Sint Anthonis (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., BA Eindhoven (NL)

(21) Appl. No.: 10/565,144

(22) PCT Filed: Jul. 12, 2004
(86) PCT No.: PCT/IB04/51196

§ 371 Date: Jan. 19, 2006

(51) Int. Cl. H05B 41/36

(52) U.S. Cl. 315/308

(57) ABSTRACT

A method for measuring a color temperature (TC) of a light source (2) comprises the steps of: measuring the partial intensity of one predefined blue spectral conpponent (B); measuring the luminance (V); and calculating the quotient BN as representing the color temperature (TC). The color temperature (TC) is calculated on the basis of a predetermined relationship between the color temperature (TC) and the quotient BN. Sensor assembly capable of generating a measuring signal containing information regarding the color temperature of a light source. Switch stage for cooperation with a sensor assembly. Driver for during a lamp with variable color temperature properties. Lamp system comprising a lamp, a sensor assembly and a lamp driver.

### FIELD OF THE INVENTION

In one aspect, the present invention relates in general to a method and device for measuring the color temperature of a light source.

More specifically, the present invention relates to a driver device for driving a light source having variable color temperature.

### BACKGROUND OF THE INVENTION

In general, there is a need for providing a method and device for measuring the color temperature of a light source. The color temperature of a light source can be defined as the temperature which a black body must have so that, in the chromaticity diagram, its color point is closest to the color point of the light source. Therefore, a conventional method of measuring color temperature comprises the step of first measuring the color point, and then calculating the closest point on the black body line. A first disadvantage of such conventional method is the relative complexity of such calculation.

Color points of a light source are usually given in a space having three coordinates x, y, z, wherein
x=X/(X+Y+Z), y=Y/(X+Y+Z), z=Z//(X+Y+Z)
wherein X, Y and Z indicate the absolute intensities of certain pre-defined spectral components. A direct way of measuring the three coordinates x, y and z involves actually measuring the three corresponding intensities, which involves the use of three color sensors, each including a corresponding color filter and a light intensity detector. Such color sensors are relatively expensive.

A more economic approach of measuring a color point is based on the fact that, per definition, x+y+z=1. Therefore, it suffices to measure only two coordinates x and y, and to calculate the third coordinate z according to z=1−x−y. This still involves the use of two color sensors. An example of a method and device according to this principle is disclosed in DE-4421919.

A main objective of the present invention is to provide a more economic way of measuring the color temperature of a light source.

In a specific aspect, the present invention relates to a driver device for a gas discharge lamp, specifically a HID lamp, more specifically a metal halide lamp. Typical lamp drivers comprise a stage generating a substantially constant current, followed by a commutator for commutating the lamp current, i.e. regularly changing the direction of the current in the lamp. Conventionally, such commutator operates at a duty cycle of 50%, i.e. in each current period, the duration of the current flow from one electrode to the other is equal to the duration of the current flow in the opposite direction. In an earlier patent application PCT/IB03/01547, the present applicant has described a gas discharge lamp with variable color properties. By changing the average lamp current, specifically the duty cycle of the lamp current, the color temperature is varied over a wide temperature range; depending on the composition of the lamp filling, the temperature range may extend from about 2500 K to about 6000 K.

In principle, there is a one-to-one relationship between duty cycle and color temperature. A problem is, that this relationship appears to be not constant in time. Therefore, if it is intended to keep the color temperature constant, it does not suffice to keep the duty cycle constant.

It is a specific objective of the present invention to solve this problem.

In a specific aspect, the present invention relates to the aspect of transferring two measuring signals to a processing circuit. Normally, this requires three wires: one wire for each measuring signal, and a common ground wire. Each wire involves costs of wiring and associated connectors. Further, with each wire, assembly complexity and assembly time increase.

It is a further objective of the present invention to reduce this problem.

### SUMMARY OF THE INVENTION

According to an important aspect of the present invention, a method is provided for measuring a color temperature, wherein the absolute intensity of one predefined blue spectral component B as well as the overall light intensity or luminance V are measured, and the quotient B/V is calculated. This method, which is based on the insight that said quotient B/V appears to have an almost linear relationship to the color temperature, involves only one relatively expensive color sensor and one relatively inexpensive luminance sensor (i.e. a light intensity sensor). A further advantage of this method is the fact that the overall light intensity, which is typically an important parameter of interest, is also directly made available; in the conventional method, the overall light intensity must be determined indirectly, or, if it is to be determined directly, a further detector is required.

According to another important aspect of the present invention, a driver for a light source is provided, specifically a gas discharge lamp, comprising a sensor assembly for generating a measuring signal indicating the color temperature, which measuring signal is fed back to a controller of the driver, which is designed to adapt its settings such as to keep the color temperature substantially constant. Advantageously, this sensor assembly comprises a blue sensor and a luminance sensor, allowing the controller to determine the ratio B/V.

According to another important aspect of the present invention, a sensor assembly comprising two sensor diodes is provided, each sensor diode being connected in series with a corresponding auxiliary diode in an opposite direction, these two series arrangements being connected anti-parallel to each other. When a supply voltage having a first polarity is applied to this assembly, a current is generated indicating the measuring signal of a first sensor diode. When the supply voltage has opposite polarity, the current indicates the measuring signal of the other sensor diode.

### BRIEF DESCRIPTION OF THE DRAWINGS

These and other aspects, features and advantages of the present invention will be further explained by the following description with reference to the drawings, in which same reference numerals indicate same or similar parts, and in which:

FIG. 1 is a block diagram, schematically showing a driver device according to the present invention;

FIG. 2 is a graph schematically illustrating lamp current as a function of time;

FIG. 3 is a graph schematically illustrating color temperature as a function of duty cycle;

FIG. 4 is a block diagram schematically illustrating a preferred embodiment of some components of a lamp driver;

FIG. 5 is a graph schematically illustrating a relationship between B/V and color temperature;

FIG. 6 is a block diagram schematically illustrating a preferred embodiment of some components of a lamp driver.

### DESCRIPTION OF THE INVENTION

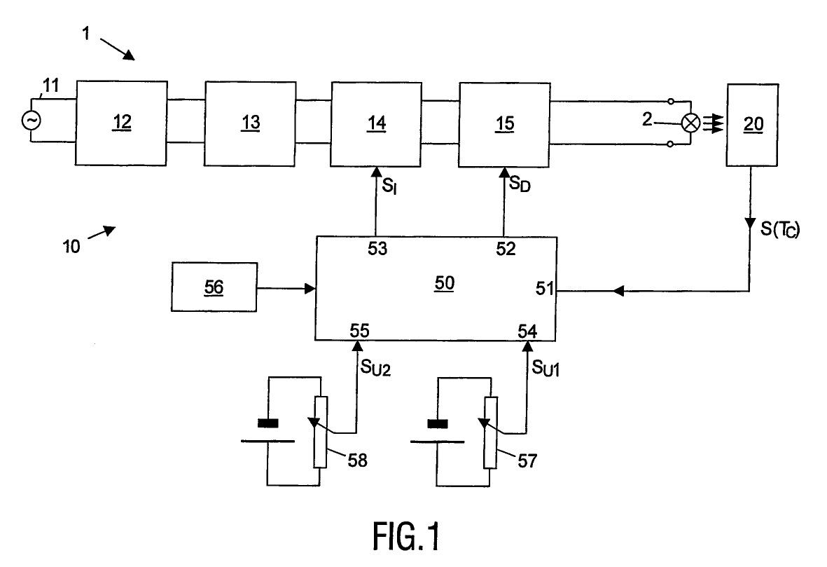

FIG. 1 is a block diagram schematically illustrating a preferred embodiment of a driver device or electronic ballast 10 according to the invention for driving a gas discharge lamp 2 in a lamp system 1 with variable color properties. The present invention will be explained for an embodiment where the ballast 10 typically comprises:

an input 11 for receiving AC mains;

a rectifier 12 for rectifying the AC mains voltage to a rectified DC voltage;

a DC/DC up-converter 13 for converting the rectified mains DC voltage to a higher DC voltage and for performing power factor correction;

a down-converter 14 for converting said higher DC voltage to a lower DC voltage (lamp voltage) and a corresponding DC current (lamp current);

and a commutator 15 for regularly changing the direction of this DC current within a very brief time (commutating periods).

It is noted, however, that the ballast may have a different design.

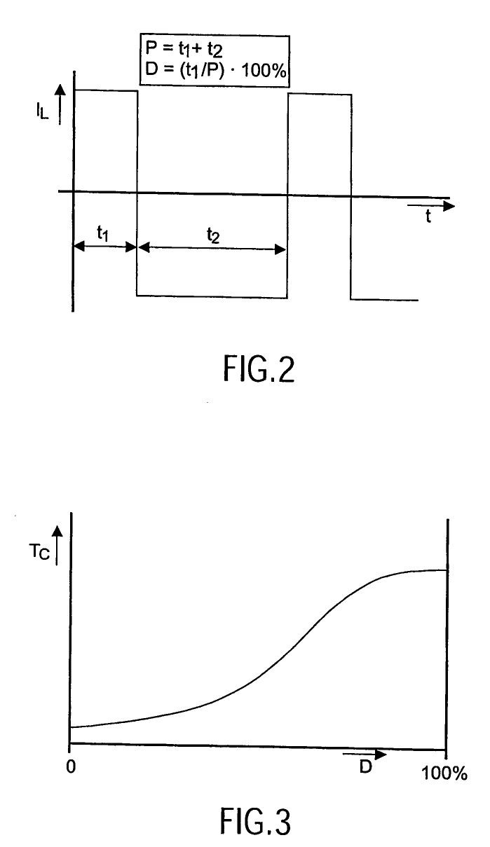

The down converter behaves as a current source. Typically, the commutator operates at a frequency in the order of about 50-400 Hz. Therefore, in principle, the lamp is operated at constant current magnitude, the lamp current regularly changing its direction within a very brief time (commutating periods), i.e. an electrode is operated as a cathode in a first part of each current period and is operated as anode during the remainder of each current period. This is illustrated by FIG. 2, which is a graph schematically illustrating the current I_{L} through the lamp 2 as a function of time. In a current period P, the current I_{L} flows from one lamp electrode to the other during a first time interval t₁, and flows in the opposite direction during a second time interval t₂, wherein P=t₁+t₂. A duty cycle D is defined as D=(t₁/P)−100%. During the current period P, the lamp current I_{L} has constant magnitude but changing direction. On a time scale larger than the current period, an average current I_{AV} may be defined as (t₁−t₂)I_{L}/P. Conventionally, a driver is designed such that its output may be considered as constituting a current source with alternating current direction but constant current magnitude, having a duty cycle of 50%; in that case, the average current I_{AV} is zero.

Some types of HID lamps have a property that the color temperature T_{C} is variable as a function of the average current I_{AV}, which can be varied by varying the duty cycle D, as explained more elaborately in PCT/IB03/01547, incorporated herein by reference. When the lamp current is given an average current I_{AV} differing from zero, a shift is induced of the distribution of the particles in the lamp, resulting, in some types of lamps, in a change in color temperature. Therefore, the driver 10 is capable of driving the lamp 2 with variable average lamp current I_{AV}.

In one possibility of implementing the present invention, the average current I_{AV} differs from zero because the current intensity during the positive current period differs from the current intensity during the negative current period, in which case the current may have a duty cycle of 50%. However, this type of implementation is not preferred, one reason being that the lamp current magnitude during one half of a current period differs from the current magnitude during the other half of the current period, i.e. the current intensity is not constant in time. Since the light intensity is proportional to the current intensity, this might lead to undesirable flicker of the lamp. Another reason is that it is relatively difficult to implement this method in existing driver designs.

In the following, the present invention will be explained in more detail for the case of a preferred implementation of the present invention, in which this disadvantage is avoided, and which furthermore is easier to implement by an appropriate software or hardware adaptation in existing lamp drivers. However, it is noted that the same or similar results can be obtained by having the positive current magnitude and the negative current amplitude differing from each other.

In this preferred implementation, the duty cycle differs from 50% and the current intensity remains constant at all times, i.e. the lamp current magnitude during the “positive” half of a current period (t₁) is equal to the current magnitude during the “negative” half of the current period (t₂) (see FIG. 2)

Thus, according to this preferred aspect of the present invention, the driver 10 is designed to have an adaptable duty cycle.

In general, the relationship between the color temperature T_{C} and the duty cycle D is as depicted in FIG. 3, where the horizontal axis represents the duty cycle and the vertical axis represents the color temperature.

The exact values of the color temperature depend on the precise composition of the lamp filling.

It has been found that the relationship between D and T_{C} is not constant over the life time of the lamp. To solve this problem, the driver 10 comprises a light sensor assembly 20, arranged in the proximity of the lamp 2, for receiving light from the lamp 2 and generating a sensor signal S(T_{C}) which contains information regarding the color temperature of the lamp light. The driver 10 further comprises a controller 50, which has a measuring input 51 and a first control output 52. The sensor assembly 20 is coupled to the measuring input 51 of the controller 50. The controller 50 is adapted for generating, at its first control output 52, a commutator control signal S_{D} for controlling the commutator 15, more particularly for controlling its duty cycle D, on the basis of the sensor signal S(T_{C}), such as to keep the sensor signal S(T_{C}) and hence the lamp color temperature constant.

The lamp driver may be designed for one specific color temperature setting in association with one specific lamp type, but typically the lamp driver will allow a user to set a specific color temperature. To this end, the controller 50 has a first user input 54 for receiving a first user control signal S_{U1} as a user-generated color setting signal. The driver 10 further comprises a control setting device 57, such as for instance a potentiometer, generating the first user control signal S_{U1} which can be varied continuously within a predetermined range. The control setting device 57 can be user-controllable, but it can also be a suitably programmed controller.

Preferably, and as shown in FIG. 1, the controller 50 is also provided with a dimming facility, i.e. a facility for setting the intensity of the light generated by the lamp 2. To this end, the controller 50 has a second user input 55 and a second control output 53. At its second user input 55, the controller 50 receives a second user control signal S_{U2} as a user-generated intensity setting signal. The driver 10 further comprises an intensity setting device 58, such as for instance a potentiometer, generating the second user control signal S_{U2} which can be varied continuously within a predetermined range. The intensity setting device 58 can be user-controllable, but it can also be a suitably programmed controller. At its second control output 53, the controller 50 generates an intensity control signal S_{I} for the down-converter 14 to control the magnitude of the lamp current I_{L}.

The controller 50 may be designed to generate its intensity control signal S_{I} on the basis of the actual second user input signal S_{U2} only. Preferably, however, in a control mode, the controller keeps the light intensity constant on the basis of the measuring signal from the sensor assembly 20.

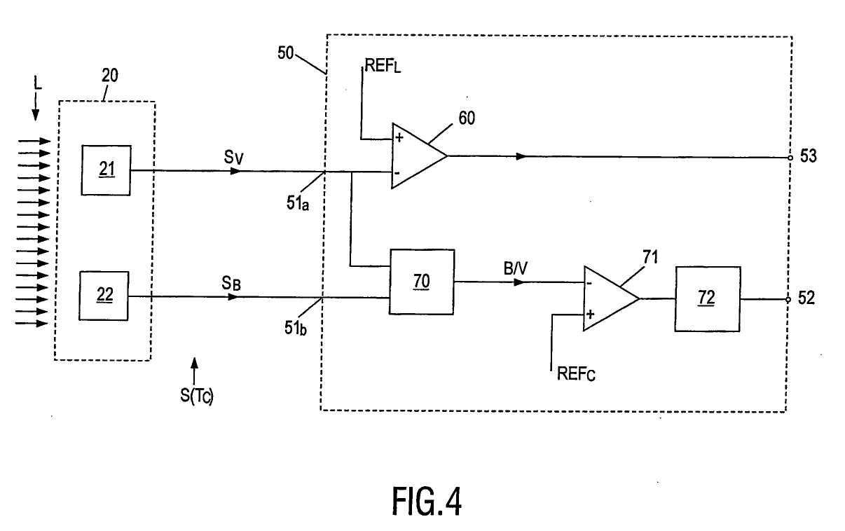

In principle, the sensor assembly 20 may be any suitable sensor assembly capable of generating an adequate measuring signal containing information regarding color temperature and light intensity. A preferred embodiment of such sensor assembly 20, which is preferred in view of its relative simplicity and relative low costs, is illustrated in the schematic block diagram of FIG. 4. This preferred sensor assembly 20 comprises two light sensors 21 and 22. The first sensor 21 is sensitive to all visible light and generates a first sensor signal S_{V} indicating the luminance of the light, i.e. the total intensity in the visible range of the spectrum; this first sensor 21 will hereinafter also be indicated as luminance sensor, and its sensor signal will hereinafter be indicated as luminance signal. The second sensor 22 is sensitive to blue light only, and generates a second sensor signal S_{B} indicating the amount of blue light, i.e. the partial intensity in the blue range of the spectrum; this second sensor 22 will hereinafter also be indicated as blue sensor, and its sensor signal will hereinafter be indicated as blue signal. In this respect, “blue light” will be understood as light having a wavelength in the range of approximately 380 nm to approximately 480 nm. Preferably, the blue sensor 22 is sensitive to substantially the entire blue range. It is noted that it is not necessary that the blue sensor 22 has equal sensitivity for all wavelengths within its sensitivity range; usually, a sensor has a peak sensitivity at one wavelength, and a decreasing sensitivity with increasing distance from this one wavelength, as will be clear to a person skilled in the art. The blue sensor 22 may have a narrow sensitivity range around any wavelength within the blue range. Preferably, the blue sensor 22 has a peak sensitivity in the order of about 440 nm.

The measuring input 51 of the controller 50 actually comprises two input terminals 51a and 51b, the first one for receiving the luminance signal S_{V} and the second for receiving the blue signal S_{B}. The luminance signal S_{V} can be used in a simple straight-forward way for controlling the light intensity. The controller 50 comprises a first comparator 60, having one input receiving the luminance signal S_{V} and having another input receiving a reference light intensity signal REF_{L}. This reference light intensity signal may be the user input signal received at the user input 55, or a reference value stored in a memory 56. The comparator output signal is coupled to the second control output 53 of the controller 50.

The controller 50 further comprises a divider 70, having two inputs coupled to the controller measuring input terminals 51a and 51b for receiving the luminance signal S_{V} as well as the blue signal S_{B}. The divider 70 is arranged to divide the blue signal S_{B} by the luminance signal S_{V}, and to generate an output signal B/V corresponding to S_{B}/S_{V}. The controller 50 comprises a second comparator 71, having one input receiving the divider output signal B/V and having another input receiving a reference color signal REF_{C}. This reference color signal may be the first user input signal S_{U1} received at the first user input 54, or a reference value stored in said memory 56. The comparator output signal is coupled to the first control output 52 of the controller 50, either directly or, in the example illustrated, via a pulse generator 72 which generates timing pulses for determining the duration of the first duty cycle time interval t₁ and the duration of the second duty cycle time interval t₂, respectively.

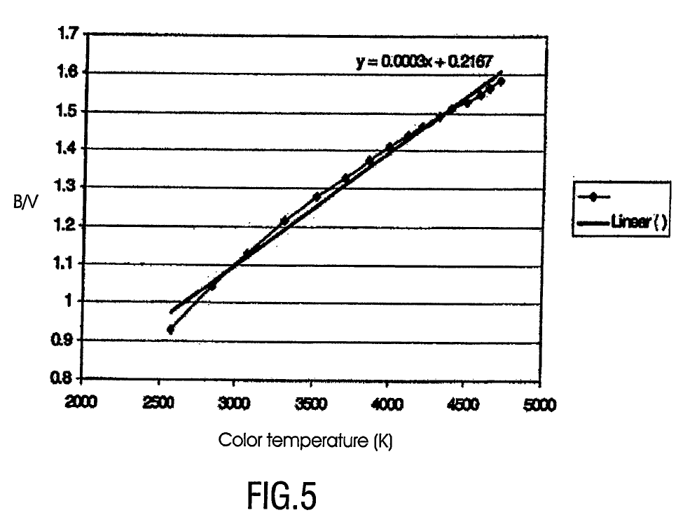

By keeping the ratio B/V substantially constant, the controller 50 assures that the color temperature remains substantially constant, based on the finding that B/V is a parameter which is a good representative for the color temperature, as illustrated by FIG. 5. FIG. 5 is a graph showing experimental results of measurements regarding the relationship between B/V (vertical axis) and the color temperature TC (horizontal axis).

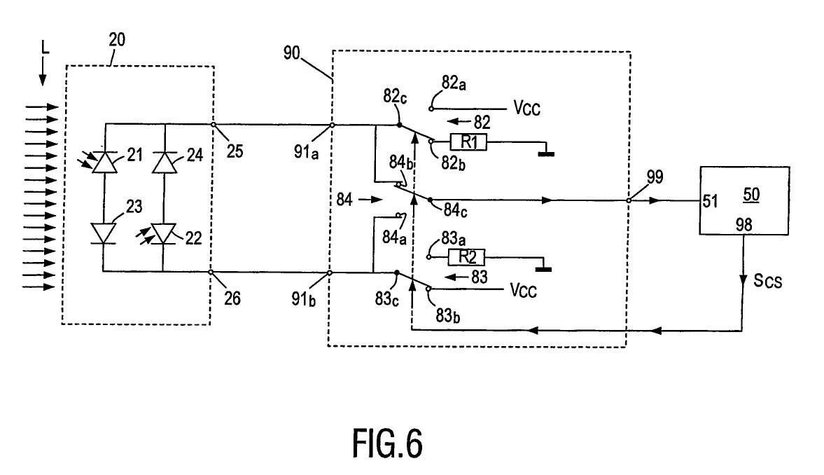

For transferring the sensor signals from two sensor devices to a processing circuit, in a preferred implementation, as illustrated in FIG. 6, only two wires are required.

In this preferred embodiment, the two sensors 21 and 22 are each implemented as a photo diode. The first photo diode 21 is connected in opposite direction in series with a first auxiliary diode 23, while the second diode 22 is connected in opposite direction in series with a second auxiliary diode 24. The free electrode of the first photo diode 21 is connected to the free electrode of the second auxiliary diode 24, and this node is connected to a first output terminal 25 of the sensor assembly 20, while the free electrode of the second photo diode 22 is connected to the free electrode of the first auxiliary diode 23, and this node is connected to a second output terminal 26 of the sensor assembly 20. In this case, the diodes 21, 23 and 22, 24 in each series connection have their anode connected together, so each diode has its cathode connected to an output terminal, but the diodes may have their orientations inverted. Also, the order of the diodes in each series connection may be reversed.

The controller 50 is provided with a commutating switch stage 90 having input terminals 91a and 91b and an output terminal 99. This stage 90 is shown as an external stage, having its output terminal 99 connected to an input terminal 51 of the controller 50, but the stage 90 and the controller 50 may be one integrated unit, as should be clear to a person skilled in the art.

The switch stage 90 comprises three switches 82, 83, 84. Each switch (82) [83] {84} has a central switch terminal (82c) [83c] {84c}, a first switch terminal (82a) [83a] {84a}, and a second switch terminal (82b) [83b] {84b}. The controller 50 has a switch control output 98, generating a switch control signal S_{CS} for controlling the operative states of the switches 82, 83, 84. In a first operative state, each switch (82) [83] {84} has its central switch terminal (82c) [83c] {84c} connected to its first switch terminal (82a) [83a] {84a}. In a second operative state, each switch (82) [83] {84} has its central switch terminal (82c) [83c] {84c} connected to its second switch terminal (82b) [83b] {84b}.

The first switch 82 has its central terminal 82c connected to the first input terminal 91a of the switch stage 90, which is connected to the first output terminal 25 of the sensor assembly 20. The second switch 83 has its central terminal 83c connected to the second input terminal 91b of the switch stage 90, which is connected to the second output terminal 26 of the sensor assembly 20. The third switch 84 has its central terminal 84c connected to the output terminal 99 of the switch stage 90.

The first switch terminal 82a of the first switch 82 and the second switch terminal 83b of the second switch 83 are connected to a positive reference voltage V_{CC}. The second switch terminal 82b of the first switch 82 and the first switch terminal 83a of the second switch 83 are connected to ground through corresponding resistors R1 and R2, respectively. The first switch terminal 84a of the third switch 84 is connected to the first input terminal 91a of the switch stage 90, and the second switch terminal 84b of the third switch 84 is connected to the second input terminal 91b of the switch stage 90.

The operation is as follows. In the first operative state, the cathodes of the first sensor diode 21 and the second auxiliary diode 24 are connected to the positive reference voltage, while the cathodes of the second sensor diode 22 and the first auxiliary diode 23 are connected to the second measuring resistor R2. The second auxiliary diode 24 blocks any current through the second sensor diode 22. The first sensor diode 21 generates a sensor current on the basis of the amount of light received by the first sensor diode 21, which current flows into the second measuring resistor R2, developing a voltage over this second resistor R2. This voltage is provided at output terminal 99 as output signal, reflecting the measuring signal from the first sensor diode 21.

In the second operative state, the situation is opposite, and the voltage developed over the first measuring resistor R1, reflecting the measuring signal from the second sensor diode 22, is provided as output signal at output terminal 99.

The controller 50 controls the switch stage 90 to regularly switch from the first operative state to the second and vice versa. In the case of measuring a color temperature, The commutation frequency of the switching stage 90 does not need to be a high frequency: since the color temperature changes only slowly, the commutation cycle may have a duration in the order of seconds. At its input 51, the controller 50 receives the measuring signals S_{V} and S_{B} from the first and second sensors 21 and 22 in an alternating way. The controller is adapted to calculate B/V=S_{B}/S_{V}, representing color temperature.

It is noted that the measuring signals B and V are influenced by the resistance values of R1 and R2. Since the controller 50 only keeps the ratio B/V constant, the exact values of B and V, and therefore R1 and R2, are not important. It is even not necessary that the controller 50 knows which signal indicates S_{B} and which signal indicates S_{V}. After all, it is immaterial whether the controller 50 is designed to keep constant the ratio B/V or the ratio V/B. In fact, if the ratio V/B is kept constant, the ratio B/V is also kept constant, per definition, and one may consider measuring B/V to be equivalent to measuring V/B. With reference to the implementation of FIG. 4, it will be clear to a person skilled in the art which modifications are required.

On the other hand, if it is desired that the controller knows which signal is which, for instance because the controller 50 is adapted to control the lamp current intensity to control the overall light intensity, as illustrated in FIG. 4, the values of the measuring resistors R1 and R2 may be chosen such that S_{V} is always larger than S_{B}, or vice versa, in which case the relative magnitudes of the first and second measuring signals give the controller 50 the required information regarding which signal is which. Suitably selecting the resistance values of the measuring resistors R1 and R2 requires, however, knowledge on the characteristics of the sensors.

It is also possible that the controller 50 is designed for performing a sensor identification test. Such a test involves the step of deliberately changing the driver settings (briefly) such that the relative amount of blue light is increased (or decreased); for instance, the driver settings may be set to values of which it is known that the relative amount of blue light is maximal (or minimal). By monitoring the response of the sensor signals, the controller 50 can determine which sensor is the blue sensor.

It should be clear to a person skilled in the art that the present invention is not limited to the exemplary embodiments discussed above, but that several variations and modifications are possible within the protective scope of the invention as defined in the appending claims.

For instance, the present invention is not applicable only to gas discharge lamps, or HID lamps. In other types of light sources, it may also be possible to achieve a variation of the color temperature by varying a control parameter (e.g. TL lamps). In that case, a driver for controlling the light source on the basis of a measuring signal indicating B/V is also useful. Further, the sensor assembly and two-wire connection as proposed by the present invention are also useful.

Further, although in the embodiment described, it suffices to measure B/V in order to keep a color temperature constant, it is also possible to actually find the value of the color temperature itself. For instance, the controller 50 may be provided with a look-up table or a formula, based on the results of a measurement like shown in FIG. 5, so that the controller 50 is capable of retrieving or calculating T_{C} once the ratio B/V is determined.

Further, in stead of using blue light, it is possible to use light from a different wavelength range within the visible range. As a very suitable alternative range, a red range is mentioned, i.e. the range from approximately 610 nm to approximately 760 nm.

Further, with reference to FIG. 6, an advantageous sensor assembly is described which has two sensors generating two measuring signals, only requiring two signal paths (wires) for connection to a signal processor. In the embodiment discussed, the sensors are photo diodes sensitive to light. However, the measuring principle involved in the sensor assembly is not limited to diodes: other types of light-sensitive devices may be used also, such as for instance light-dependent resistors (LDRs). The measuring principle involved in the sensor assembly is even not limited to measuring light: the design of the sensor assembly can be applied using any type of sensor, sensitive to a certain parameter such that at least one electrical characteristic, e.g. the electrical resistance between two sensor terminals (LDR) or a current generated (photodiode), depends on this parameter. The sensor assembly comprises a series connection of a diode with such sensor: as a result, a measuring signal (current) is only generated when a voltage having the correct polarity is applied across this series connection; in the case of opposite polarity, the series diode will block any measuring signal from its associated sensor. The sensor assembly further comprises a second series connection of a second diode with a second sensor (which need not necessarily be of the same type as the first sensor: the parameters to be measured may be quite different). The second series connection is connected anti-parallel to the first series connection, as far as the directions of the diodes is concerned.

Further, with reference to FIG. 6, the switch stage 90 is explained in relation to positive supply voltage V_{CC} and ground. However, it is also possible to use a negative reference voltage. Also, the measuring resistance may be connected in series with the reference voltage instead of the ground terminal.

In the above, the present invention has been explained with reference to block diagrams, which illustrate functional blocks of the device according to the present invention. It is to be understood that one or more of these functional blocks may be implemented in hardware, where the function of such functional block is performed by individual hardware components, but it is also possible that one or more of these functional blocks are implemented in software, so that the function of such functional block is performed by one or more program lines of a computer program or a programmable device such as a microprocessor, microcontroller, digital signal processor, etc.

1. Method for measuring a color temperature (T_{C}) of a light source (2), comprising the steps of:
measuring the partial intensity (B) of a predefined spectral region narrower than the visible range;
measuring the total intensity (V) in the visible range; and
calculating a ratio (B/V) of said partial intensity (B) to said total intensity (V) as representing the color temperature (T_{C}).

2. Method according to claim 1, wherein the color temperature (T_{C}) is calculated on the basis of a predetermined relationship between the color temperature (T_{C}) and said ratio (B/V).

3. Method according to claim 1, wherein said predefined spectral region is located in the blue part of the spectrum.

4. Method according to claim 3, wherein said blue range extends from approximately 380 nm to approximately 480 nm.

5. Method according to claim 1, wherein said predefined spectral region is located in the red part of the spectrum.

6. Method according to claim 5, wherein said red range extends from approximately 610 nm to approximately 760 nm.

7. Sensor assembly (20), for measuring at least one parameter, comprising:
a first parameter sensor (21) having at least one parameter-dependent electrical characteristic;
a first diode (23) connected in series with said first parameter sensor (21).

8. Sensor assembly according to claim 7, wherein said first parameter sensor (21) is a light sensor, preferably a photo diode.

9. Sensor assembly according to claim 7, for measuring at least two parameters, further comprising:
a second parameter sensor (22) having at least one parameter-dependent electrical characteristic;
a second diode (24) connected in series with said second parameter sensor (22);
wherein the series combination of second parameter sensor (22) and second diode (24) is connected anti-parallel to the series combination of first parameter sensor (21) and first diode (23).

10. Sensor assembly according to claim 7, wherein a free terminal of the first parameter sensor (21) is coupled to a first output terminal (25);
and wherein a free terminal of the first diode (23) is coupled to a second output terminal (26).

11. Sensor assembly (20), capable of receiving light (L) from a light source (2) and capable of generating a measuring signal (S(Tc)) containing information regarding the color temperature (T_{C}) of the light source (2);
the sensor assembly (20) comprising a first sensor (21) adapted for measuring luminance and a second sensor (22) adapted for measuring the partial intensity of a predefined spectral region narrower than the visible range.

12. Sensor assembly according to claim 11, wherein said second sensor (22) has a sensitivity range substantially corresponding to a blue range, said second sensor (22) preferably having a peak sensitivity at approximately 440 nm.

13. Sensor assembly according to claim 11, wherein said second sensor (22) has a sensitivity range substantially corresponding to a red range, said second sensor (22) preferably having a peak sensitivity at approximately 660 nm.

14. Sensor assembly according to claim 11, designed in accordance with claim 8.

15. Switch stage (90), for cooperation with a sensor assembly according to claim 10, the switch stage comprising:
a first controllable switch (82), having a central terminal (82c) coupled to a first input (91a), having a first terminal (82a) coupled to a first reference voltage (V_{CC}), and having a second terminal (82b) coupled via a first measuring resistor (R1) to a second reference voltage (ground) differing from the first reference voltage (V_{CC});
a second controllable switch (83), having a central terminal (83c) coupled to a second input (91b), having a first terminal (83b) coupled to a first reference voltage (V_{CC}), and having a second terminal (83a) coupled via a second measuring resistor (R2) to a second reference voltage (ground) differing from the first reference voltage (V_{CC});
a third controllable switch (84), having a central terminal (84c) coupled to an output (99), having a first terminal (84a) coupled to the second input (91b), and having a second terminal (84b) coupled to the first input (91a).

16. Driver (10) for driving a lamp (2) with variable color temperature properties, the driver comprising:
a sensor assembly (20), capable of receiving light (L) from the light source (2) and capable of generating a measuring signal (S(Tc)) containing information regarding the color temperature (T_{C}) of the light source (2);
a controller (50), having an input (51) coupled to receive the measuring signal (S(Tc)) from the sensor assembly (20), and adapted to control a lamp current generating component (14; 15) on the basis of the measuring signal (S(Tc)).

17. Driver according to claim 16, wherein the controller is designed to keep the measuring signal (S(Tc)) at a desired value.

18. Driver according to claim 16, wherein the controller (50) comprises:
a divider (70) having its inputs connected for receiving a luminance signal (S_{V}) and an intensity signal (S_{B}) indicating the partial intensity (B) of a predefined spectral region narrower than the visible range;
a comparator (71) having a first input receiving an output signal (B/V) from the divider (70) and having a second input receiving a reference signal (REF_{C}).

19. Driver according to claim 18, further comprising a pulse generator (72) having an input receiving an output signal from the comparator (71).

20. Driver according to claim 18, comprising a sensor assembly (20) according to claim 11.

21. Driver according to claim 16, wherein the controller (50) comprises:
a comparator (60) having a first input connected for receiving a luminance signal (S_{V}), and having a second input receiving a reference signal (REF_{L}).

22. Driver according to claim 16, comprising a switch stage (90) according to claim 15.

23. Driver according to claim 22, comprising a sensor assembly (20) according to claim 10.

24. Lamp system (1), comprising:
a lamp (2) with variable color temperature properties;
a sensor assembly according to claim 11;
a lamp driver according to claim 16.
